(19) United States
(12) Patent Application Publication
(10) Pub. No.: US 2025/0204491 A1
(43) Pub. Date: Jun. 26, 2025

(54) IMPLEMENT FOR ADJUSTING SIZE OF ELIZABETHAN COLLAR

(71) Applicant: Nobuyoshi MIZOBATA, Kobe-shi (JP)

(72) Inventor: Nobuyoshi MIZOBATA, Kobe-shi (JP)

(21) Appl. No.: 18/277,300

(22) PCT Filed: Mar. 16, 2022
(86) PCT No.: PCT/JP2022/013768

§ 371 Date: Feb. 19, 2025

(30) Foreign Application Priority Data
Mar. 17, 2021 (JP) 2021-078833

(51) Int. Cl. A01K 13/00

(52) U.S. Cl. CPC A01K 13/006

(57) ABSTRACT

In snap-button-type Elizabethan collars, a button is latched only at intervals, and it is impossible to make fine adjustments to the size. Therefore, such Elizabethan collars have presented issues in terms of difficulty of adjustment at intended sizes, such as when the Elizabethan collar slips off of an animal on which the collars is to be worn, or when the collar is too tight and cannot be worn, However, these issues are resolved by adding a size adjustment implement. In the present invention, a belt-form size adjustment implement (reference 4 in FIG. 2) is formed, the size adjustment implement being a simple component of a snap button, and having characteristics such that a protrusion-size button and a recess-side button are driven into the front and rear thereof. A protrusion Ia of the size adjustment implement and a recess 4b of an original Elizabethan collar body, and a recess 2a of the size adjustment implement and a protrusion 3b of the original Elizabethan collar body, are respectively combined where the protrusion 3b and the recess 4b are predicted.

### TECHNICAL FIELD OF THE INVENTION

The present invention belongs to the technical field of Elizabeth Collar,

### BACKGROUND OF THE INVENTION

Traditionally, there is an Elizabethan collar that is used when an animal licks a wound, affected area, rash, etc. after surgery and gets worse. Snap-type Elizabethan collars can only be buttoned between designated buttons, making it impossible to make fine adjustments to the size. As a result, there were problems such as the Elizabethan collar falling off the animal or being too tight to put on.

Elizabeth collar shown in 6 in FIG. 4 and Patent Document 1, There are three buttons in a row, and the size can be adjusted in three stages. However, sometimes three size adjustments are not enough. This Elizabethan collar has different sizes (S, M, L, XL) and button widths of 3 cm-7 cm, which makes it difficult to fine-tune the size. In reality, the collar was attached relying on the softness of the animal's fur, and the shorter the animal's fur, the more difficult it was to get the size right.

Animals can gain weight, grow winter fur, and change size in a short period of time. The appropriate size will be different if you use the collar during the day when you are active and when you use it while you sleep. If it's not the right size, the animal is under stress.

### PRIOR ART LITERATURE

Patent Document 1, U.S. Pat. No. 5,186,640, Paragraph No. 0015 FIG. 1

### SUMMARY OF THE INVENTION

### Problem to be Solved by the Invention

The problems to be solved by this invention are as follows. For snap-button Elizabethan collars, the button is fastened at a location other than the designated button placement to allow for more detailed size adjustment.

### Means for Solving the Problem

To make a belt-like size adjustment device having the feature of driving the convex side button and concave side button of a snap button on the back and front side.

By combining this device with an Elizabethan collar and shifting the button from its original location, the size can be adjusted only around the animal's neck. Adding a button to this device allows it to function not only for size adjustment but also as a size extension device.

### Effect of the Invention

By adding a size adjustment device, it is possible to fasten the buttons with fine size adjustments other than the button spacing of the Elizabethan collar body. Wearing an Elizabethan collar in an appropriate size reduces the burden on the target animal.

Originally, if you want to make a beautiful cone-shaped Elizabethan collar, this is like a truncated cone shaped like a megaphone, we need to place buttons on both the tip of the nose and around the neck of the Elizabethan collar. A sizing device for the button towards the animal's snout should also be considered.

In the present invention, since only the size around the neck is adjusted, the weight can be kept small, and the labor of the person who attaches it can be reduced.

The Elizabethan collar sizing device also functions as an extension device. Some dog and cat breeds are thicker around the neck. Elizabethan collars on the market have unique standards such as S, M, L, and XL, but depending on the type and individual of the animal, the length around the neck is often insufficient. Use of the present invention avoids the need to change to a heavy and bulky Elizabethan collar.

### BRIEF DESCRIPTION OF THE DRAWINGS

FIG. 1 shows the size adjustment tool. Plan view front side 1, side view. “Embodiment 1”

FIG. 2 Shows the attachment button numbers of the size adjustment device 4 and the Elizabethan collar 5. “Embodiment 1”

FIG. 3 is a perspective view of the size adjustment device when it is attached to an Elizabethan collar and an animal. “Embodiment 1”

FIG. 4 shows a comparison of the button positions of a conventional Elizabethan collar and an Elizabethan collar with a size adjustment device attached. “Embodiment 1”

FIG. 5 is a perspective view showing the button position relationship when the Elizabethan collar is made into a three-dimensional shape. “Embodiment 1”

FIG. 6 is a cross-sectional view of the Elizabethan collar as seen from the side when the collar is worn by an animal in a diagonally downward button arrangement that deflects the deformation of the Elizabethan collar to the outside. and enlarged view. “Embodiment 1”

FIG. 7 is a cross-sectional view from the side of a rejected prototype in which the buttons are not arranged diagonally downward, when worn by an animal. and enlarged view. “Embodiment 1”

FIG. 8 is a comparison diagram of the button positions of a conventional Elizabethan collar and an Elizabethan collar showing how to use a size adjustment device as an extension device. “Embodiment 2”

FIG. 9 is a diagram showing the maximum width state of the size extension device. “Embodiment 2”

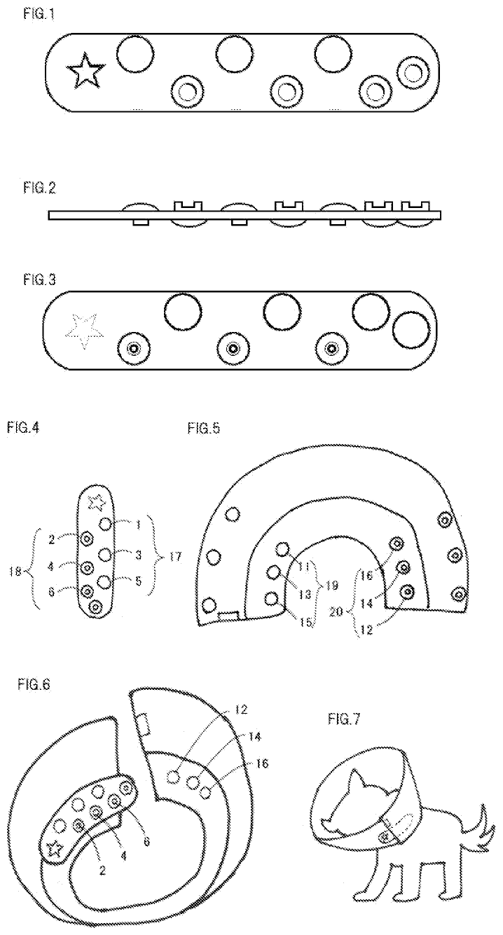

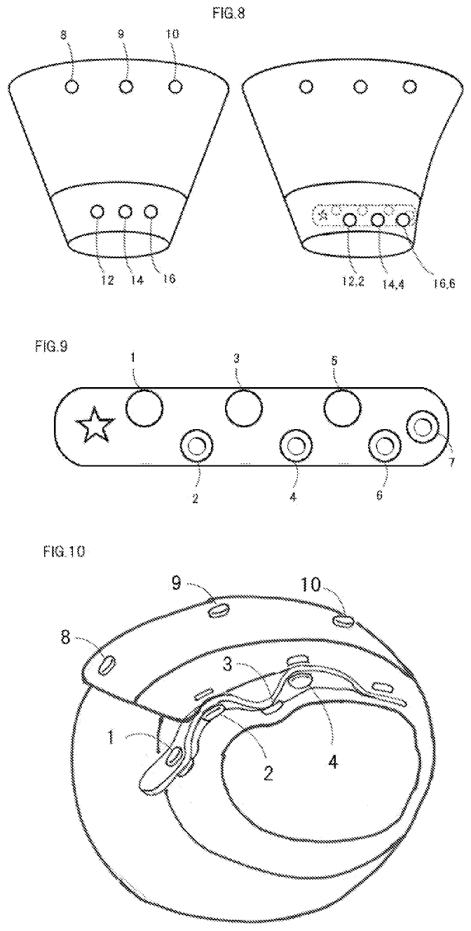

### EMBODIMENT 1

In this project, the position of the button is shifted only around the neck in the three-dimensional Elizabethan collar, so it cannot be realized with a hard material that does not allow even the slightest deformation. In this project, we will use an Elizabethan collar as a model example, which is made by combining a transparent plastic material for the nose of the animal and a flexible urethane material for the neck area. The size adjuster uses synthetic leather that is easy to bend and has little elasticity. Linen cloth is also suitable as a material due to its characteristics.

FIG. 4 is a comparison diagram of the button positions of solid body 6 (megaphone type) of Elizabeth color and solid body 7 which is partially deformed when the size adjustment device is attached. When a snap-type Elizabethan collar is made into a three-dimensional model, the positions of the button toward the snout of the animal at the top and the button toward the neck of the animal at the bottom are predetermined. (Buttons C1 and B1, C3 and B3, C5 and B5 correspond respectively.) Combine the size adjustment device 8 with the Elizabethan collar. Normally, the buttons would stay exactly at the A1, A3, and A5 positions, but using the size adjustment tool 8, adjust the size by shifting the positions diagonally downward to A2, A4, and A6.

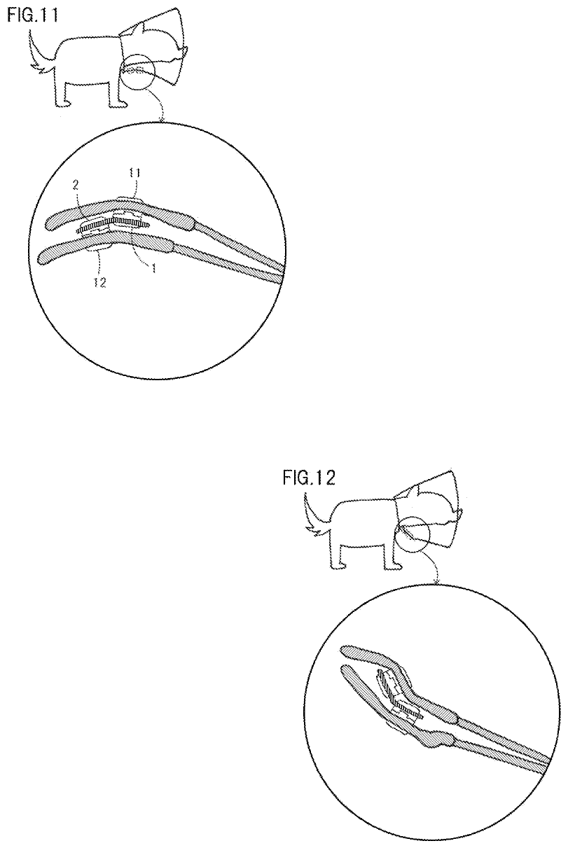

FIG. 5 is a perspective view showing the button position relationship from the perspective of the neck side. Even though the material is easy to bend, the horizontal positional relationship, which is directly related to size adjustment, remains the same, and button installation points A2 and A4 are bent and widened as much as possible to make it easier to understand visually. The position where it should be fastened at A1 has been shifted horizontally to A2, resulting in an expanded size.

At this time, the position of button C1 in the direction of the animal's snout does not change even if the size adjustment device is attached. If the next size is appropriate, select the size using the buttons originally attached to the C3 Elizabethan collar after removing the size adjustment device.

FIG. 6 is a sectional view and an enlarged view of the animal wearing the device as seen from the side. Engage the convex button (B3) on the urethane that goes around the outside of the neck with the concave button (A4) that is shifted diagonally downward on the size adjustment device. The engaged buttons pull outward and downward, applying force and deforming a portion of the Elizabethan collar body by deflecting it outward.

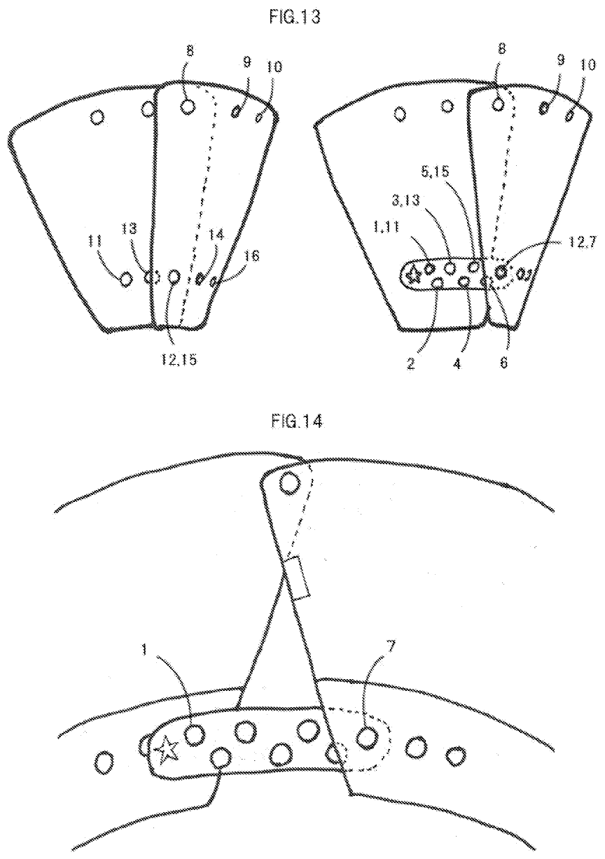

When the size adjustment device is worn, there is a force that tries to return the plastic and urethane that form the three-dimensional shape to their original shape, and a force that tries to distance the button due to the size adjustment device. If the button position of the size adjustment device is shifted to the side or diagonally upward rather than diagonally downward as in the present invention, the button will be rolled inward together with the urethane due to the force applied (FIG. 7), and the button will hit the wearing animal at a sharp angle. If this happens, the animal's skin may become abraded or cause new wounds. To prevent this, a rule is put in place to shift the button position diagonally downward in addition to the horizontal movement required for size adjustment, so that deformation of the Elizabethan collar is deflected outward.

### EMBODIMENT 2

The size adjustment device of the present invention not only adjusts the size at an intermediate position between buttons, but also functions as a size extension device. A button has been added at the position of size adjustment device 8 in the illustration. In FIG. 8, in the case of the ready-made product 9, the maximum neck width can be adjusted at position B1, but when a size adjustment device is used, the size can be extended to two stages, A6 and A7.

In FIG. 9, the size adjustment tool is an independent object, so the button position can be changed without being limited to the three button positions. In that case, it is theoretically possible to extend the size from A1 to A7, which is the maximum length of the combination between the buttons.

### EXPLANATION OF MARKS

1 . . . . Size adjustment device plan view front side
2 . . . . Size adjustment tool side view
3 . . . . Size adjustment device plan view back side
4 . . . . Size adjustment tool and button number
5 . . . . Elizabethan collar and button number
6 . . . . Traditional Elizabethan collar
7 . . . . Elizabethan collar with size adjustment device attached
8 . . . . Button location on size adjustment device
9 . . . . This shows the maximum neck circumference of a conventional Elizabethan collar.
10 . . . . Elizabeth collar with extended size using size adjustment device 1a, 2a, 3b,4b . . . . Grouping of buttons when attaching size adjustment devices
A1, A2, A3, A4, A5, A6, A7 . . . . Size adjustment device button position number
B1, B2, B3, B4, B5, B6 . . . . Elizabethan collar button position number around the animal's neck
C1, C3, C5 . . . . Button position number in the direction of the animal nose on the Elizabethan collar body

1. A size adjustment device for Elizabethan collars, in which a convex snap button and a concave snap button are attached to the front and back of a belt-like device, and then combined with an Elizabethan collar, the button position is shifted from the original button position to adjust the size of only the part that touches the animal's neck.

2. A size adjustment device for Elizabethan collars according to claim 1, wherein the buttons are arranged in a manner that deflects deformation of the Elizabethan collar outward by shifting the buttons not only horizontally, which directly affects size adjustment, but also diagonally downward.

3. The Elizabethan collar adjustment device according to claim 1, which also functions as a size extension device by adding a button.
